(19) United States
(12) Patent Application Publication
(10) Pub. No.: US 2006/0094319 A1
(43) Pub. Date: May 4, 2006

(54) Extensible laminate having elastics of differing elastic properties

(75) Inventor: Uwe Schneider, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/918,931

(22) Filed: Nov. 3, 2004

(51) Int. Cl. D04H 13/00; D04H 3/00; B32B 5/26; D04H 1/00; D04H 5/00

(52) U.S. Cl. 442/329; 442/328; 442/344; 442/381

(57) ABSTRACT

An extensible laminate having a first web material, a second web material, a first elastic and a second elastic having different stretch properties. The elastics are laminated between the first and second materials. The elastics have substantially the same equilibrium points within the laminate. The elastics are pre-strained at different strain rates. The elastics may have different basis weight. The elastics may have different diameters. The elastics may be constructed of different materials. The elastics may be extruded in situ. The extensible laminate may further have a first stretch region containing multiple elastics and a second stretch region also containing multiple elastics, wherein the spacing between elastics in the first region is different than the spacing in said the second region.

### FIELD OF THE INVENTION

The present invention relates to an extensible laminate having elastics of differing elastic properties. More particularly, the present invention relates to an extensible laminate having differing elastic properties yet having substantially the same equilibrium point within said laminate.

### BACKGROUND

Extensible laminates are frequently used in the manufacturing of many disposable absorbent articles, such as diapers. For example, extensible laminates are used in forming an extensible waist region within a diaper so as to provide improved stretch and fit properties. In an effort to provide targeted stretch, absorbent articles are commonly made from extensible laminates containing elastics of differing stretch properties. For instance, a single laminate may comprise a first and second elastic wherein the first elastic has a larger diameter than the second elastic. However, one known problem of such a technique is that the resulting laminate is not linear in shape. Not only does this present product design limitations, but more importantly, this problem presents major issues with the web handling of said laminate. More specifically, material webs which are not linear often behave unpredictably when being processed in a manufacturing line.

What is needed is an extensible laminate having elastics of differing elastic properties so as to provide different areas of stretch. Furthermore, it may be desirable to provide said extensible laminate within a linear web of material such that it may be predictably processed in the manufacturing line.

### SUMMARY OF THE INVENTION

An extensible laminate having a first web material, a second web material, a first elastic and a second elastic having different stretch properties. The elastics are laminated between the first and second materials. The elastics have substantially the same equilibrium points within the laminate. The elastics are pre-strained at different strain rates. The elastics may have different basis weight. The elastics may have different diameters. The elastics may be constructed of different materials. The elastics may be extruded in situ.

The extensible laminate may further have a first stretch region containing multiple elastics and a second stretch region also containing multiple elastics, wherein the spacing between elastics in the first region is different than the spacing in said the second region.

### BRIEF DESCRIPTION SHOWN IN THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1 is a schematic front elevational view of a conventional diaper;

FIG. 2a is a schematic front elevational view of a conventional diaper having elastics of differing diameters;

FIG. 2b is a schematic front elevational view of a conventional diaper having elastics of differing spacing;

FIG. 3a is a schematic top elevational view of a conventional extensible laminate which is non-linear in shape;

FIG. 3b is a schematic top elevational view of an extensible laminate in accordance with the present invention;

FIG. 4a is a schematic front elevational view of a diaper having elastics of differing diameters in accordance with the present invention;

FIG. 4b is a schematic front elevational view of a diaper having elastics of differing spacing in accordance with the present invention;

FIG. 5 is a schematic of an exemplary manufacturing process for making absorbent articles in accordance with the present invention;

FIG. 6a is a schematic elevational view of the components of a laminate prior to being stretched;

FIG. 6b is a schematic elevational view of the components of the laminate after being stretched but before being relaxed;

FIG. 6c is a schematic elevational view of the components of the laminate after being stretched and after being relaxed;

FIG. 7a is a schematic elevational view of a sample S₁ been measured from a web of said laminate;

FIG. 7b is a schematic elevational view of sample S₁ haven being cut from said laminate web;

FIG. 7c is a schematic elevational view of sample S₁ being stretched until the corrugations are substantially flattened;

FIG. 8a is an exemplary, conceptual stress-strain curve for a single elastic (or multiple elastics having homogenous properties) having an original relaxed length of 100 cm;

FIG. 8b is an exemplary, conceptual stress-strain curve showing resistive force, F_{R,} which depicts the amount of resistive force exerted by the web materials in an effort to resist formation of corrugations;

FIG. 8c is an exemplary, conceptual stress-strain curve for a laminate having a single elastic;

FIG. 9a is an exemplary, conceptual stress-strain curve for a laminate having two distinct elastics;

FIG. 9b is an exemplary, conceptual stress-strain curve for the present invention;

FIG. 10a depicts an exemplary manufacturing process for making absorbent articles in accordance with the present invention;

FIG. 10b is a close-up of the chilled drum from FIG. 10a;

FIG. 10c is a cross-sectional view of the chilled drum from FIG. 10b;

FIG. 11 depicts another exemplary design for the chilled drum in FIG. 10a;

FIG. 12 depicts yet another exemplary design for the chilled drum in FIG. 10a;

FIG. 13 depicts another exemplary manufacturing process for making absorbent articles in accordance with the present invention;

FIG. 14 is a schematic top elevational view of a conventional extensible laminate which has two types of elastics having different diameters, said laminate being non-linear in shape;

FIG. 15a is a schematic top elevational view of an extensible laminate which has two types of elastics having different diameters, said laminate being linear in shape, in accordance with the present invention;

FIG. 15b is a cross-sectional view of an exemplary configuration of a laminate in accordance with the present invention, wherein the elastics have substantially the same diameter and spacing but have varying elastic properties;

FIG. 15c is a cross-sectional view of another exemplary configuration of a laminate in accordance with the present invention, wherein the elastics have substantially the same diameter but have varying spacing;

FIG. 15d is a cross-sectional view of another exemplary configuration of a laminate in accordance with the present invention, wherein the elastics have substantially the same spacing but have varying diameters;

FIG. 16a is an exemplary, conceptual stress-strain curve depiction of a laminate incorporating the present invention;

FIG. 16b is a conceptual stress-strain curve depiction of a laminate that does not incorporate the present invention; and

FIG. 16c is a conceptual stress-strain curve, displaying only the first extension cycle, for the definition of available stretch. The stretched length of the laminate is characterized by a sudden progressive force incline in the extension cycle of the stress-strain curve.

### DETAILED DESCRIPTION OF THE INVENTION

Definitions:

An “elastic,” “elastomer” or “elastomeric” refers to polymers exhibiting elastic properties. They include any material that upon application of a force to its relaxed, initial length can stretch or elongate to an elongated length more than 10% greater than its initial length and will substantially recover back to about its initial length upon release of the applied force.

An “extrusion apparatus” or “extruder” refers herein to any machine capable of extruding a molten stream of material such as a polymeric through one or more extrusion dies.

The term “extrude” or “extruding” refers herein to a process by which a heated elastomer is forced through one or more extrusion dies to form a molten stream of elastic that cools into a solid.

The term “joined” herein encompasses configurations whereby a material or component is secured directly or indirectly (by one or more intermediate members) to another material or component. An example of indirect joining is an adhesive. Direct bonding includes heat in conjunction with or alternatively pressure bonding. Joining may include any means known in the art including, for example, adhesives, heat bonds, pressure bonds, ultrasonic bonds, and the like.

The term “nonwoven” refers herein to a material made from continuous (long) filaments (fibers) and/or discontinuous (short) filaments (fibers) by processes such as spunbonding, meltblowing, and the like. Nonwovens do not have a woven or knitted filament pattern.

Nonwovens are typically described as having a machine direction and a cross direction. The machine direction is the direction in which the nonwoven is manufactured. The cross direction is the direction perpendicular to the machine direction. Nonwovens are typically formed with a machine direction that corresponds to the long or rolled direction of fabrication. The machine direction is also the primary direction of fiber orientation in the nonwoven.

The term “absorbent article” herein refers to devices which absorb and contain body exudates and, more specifically, refers to devices which are placed against or in proximity to the body of the wearer to absorb and contain the various exudates discharged from the body, such as: incontinence briefs, incontinence undergarments, absorbent inserts, diaper holders and liners, feminine hygiene garments and the like.

The term “disposable” is used herein to describe absorbent articles which generally are not intended to be laundered or otherwise restored or reused as absorbent articles (i.e., they are intended to be discarded after a single use and, preferably, to be recycled, composted or otherwise discarded in an environmentally compatible manner).

The term “unitary” absorbent article refers to absorbent articles which are formed of separate parts united together to form a coordinated entity so that they do not require separate manipulative parts like a separate holder and/or liner.

The term “diaper” herein refers to an absorbent article generally worn by infants and incontinent persons about the lower torso.

The term “pant”, as used herein, refers to disposable garments having a waist opening and leg openings designed for infant or adult wearers. A pant may be placed in position on the wearer by inserting the wearer's legs into the leg openings and sliding the pant into position about the wearer's lower torso. A pant may be preformed by any suitable technique including, but not limited to, joining together portions of the article using refastenable and/or non-refastenable bonds (e.g., seam, weld, adhesive, cohesive bond, fastener, etc.). A pant may be preformed anywhere along the circumference of the article (e.g., side fastened, front waist fastened). While the term “pant” is used herein, pants are also commonly referred to as “closed diapers”, “prefastened diapers”, “pull-on diapers”, “training pants” and “diaper-pants”. Suitable pants are disclosed in U.S. Pat. No. 5,246,433, issued to Hasse, et al. on Sep. 21, 1993; U.S. Pat. No. 5,569,234, issued to Buell et al. on Oct. 29, 1996; U.S. Pat. No. 6,120,487, issued to Ashton on Sep. 19, 2000; U.S. Pat. No. 6,120,489, issued to Johnson et al. on Sep. 19, 2000; U.S. Pat. No. 4,940,464, issued to Van Gompel et al. on Jul. 10, 1990; U.S. Pat. No. 5,092,861, issued to Nomura et al. on Mar. 3, 1992; U.S. patent application Ser. No. 10/171,249, entitled “Highly Flexible And Low Deformation Fastening Device”, filed on Jun. 13, 2002; U.S. Pat. No. 5,897,545, issued to Kline et al. on Apr. 27, 1999; U.S. Pat. No. 5,957,908, issued to Kline et al on Sep. 28, 1999, the disclosure of each of which is incorporated herein by reference.

Description:

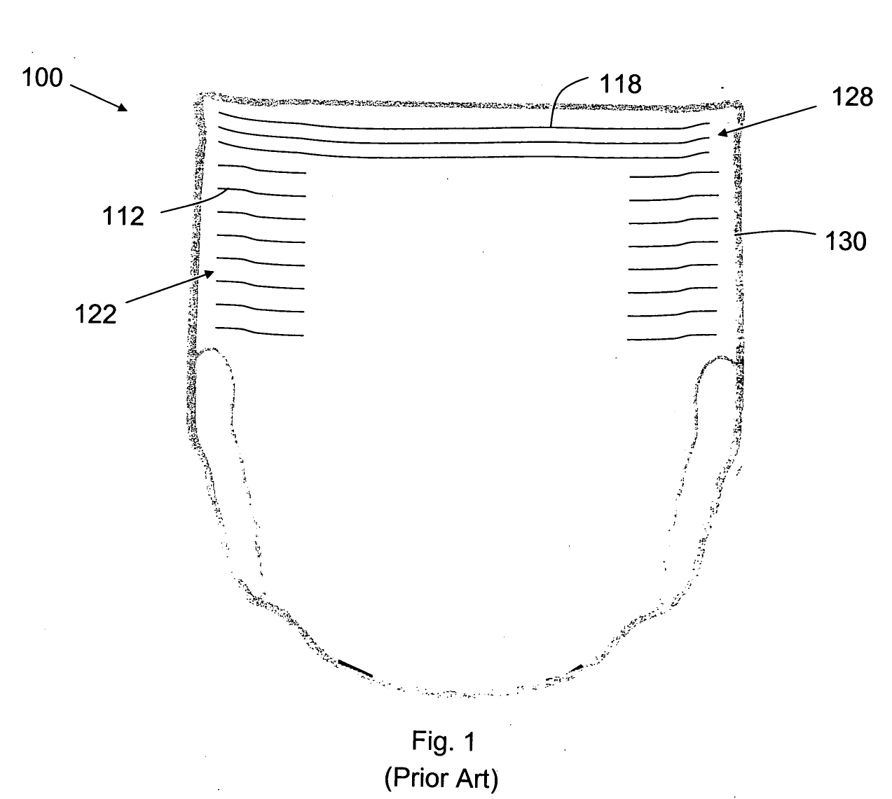

FIG. 1 depicts a conventional absorbent article 100 having elastics 112, 118. A first set of elastics 122 having a plurality of first elastics 112 may be provided along the longitudinal side edges 130. A similar first set of elastics 122 may also be provided on the opposing longitudinal side edge. A second set of elastics 128 having a plurality of second elastics 118 may be provided along the lateral end edge 135.

In this first conventional absorbent article 100, the following product characteristics are emphasized: (a) the first set of elastics 122 consists of elastics 112 being substantially identical (e.g., diameter, material type, stretch properties, etc.) (b) the first set of elastics 122 consists of elastics 112 being spaced substantially the same from each other, and (c) longitudinal side edges 130 are substantially perpendicular to lateral end edge 135. Consequently, this first conventional absorbent article 100 has a single, standard stretch zone along its side edges 130 with a resulting overall product outline being linear in shape.

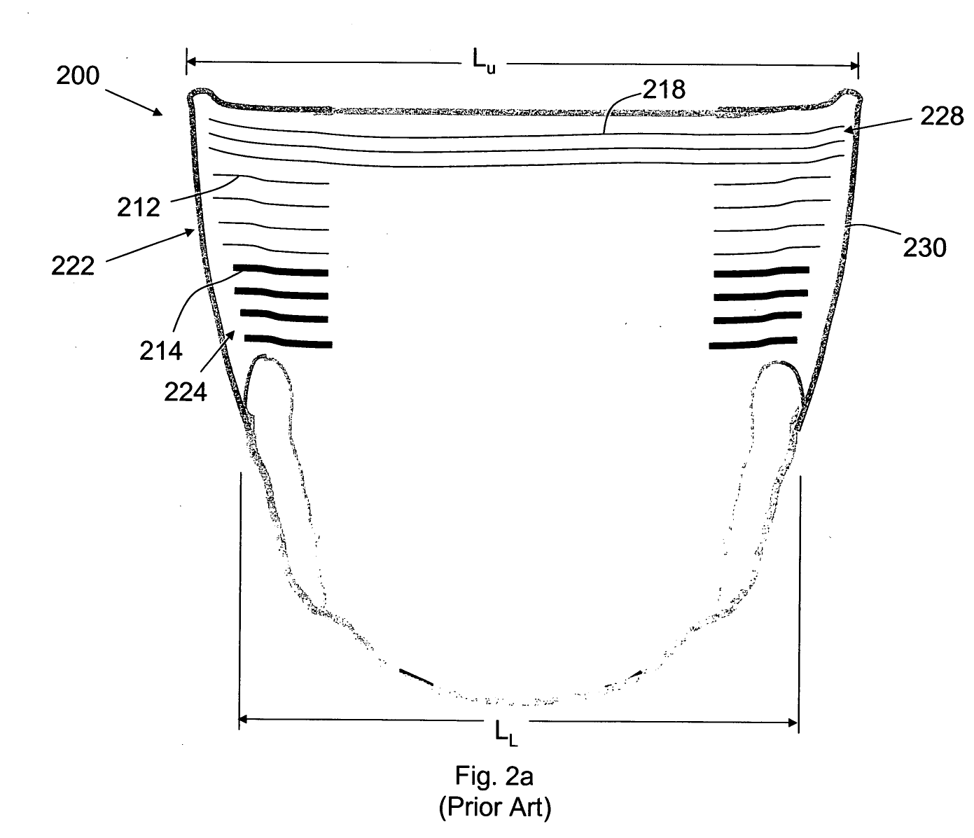

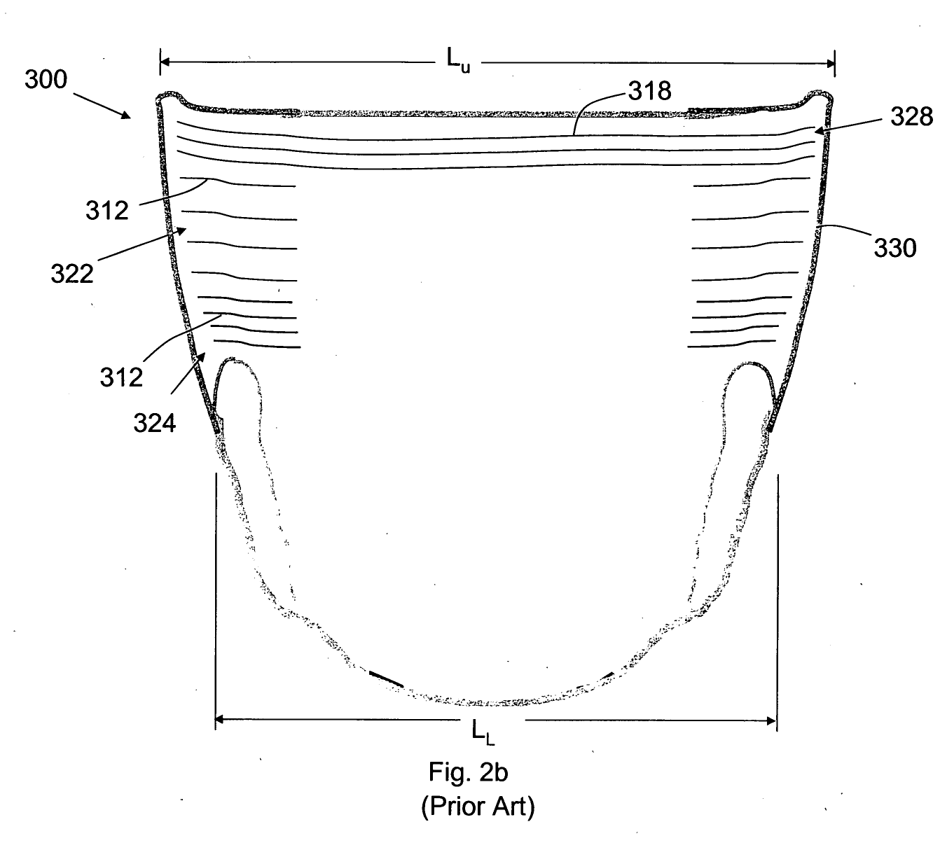

FIG. 2a depicts a conventional absorbent article 200 having elastics 212, 214 and 218. A first set of elastics 222 having a plurality of first elastics 212 may be provided along the longitudinal side edge 230. A similar first set of elastics 222 may also be provided on the opposing longitudinal side edge 230. A second set of elastics 224 having a plurality of second elastics 214 may also be provided along the longitudinal edges 230. Lastly, a third set of elastics 228 consisting of elastics 318 may be provided along the lateral end edge 235.

In this second conventional absorbent article 200, the following product characteristics are emphasized: (a) first elastics 212 are not substantially identical to second elastics 214, (b) elastics 212, 214 within first and second sets 222, 224 are spaced substantially the same from each other, and (c) longitudinal side edges 230 are not substantially perpendicular to lateral end edge 235. Consequently, this second conventional absorbent article 200 has two standard stretch zones along its side edges 230 with a resulting overall product outline being curved in shape. Said curved shape is illustrated by a difference in length between a lower lateral dimension, L_{L}, and a higher lateral dimension, L_{U}.

FIG. 2b depicts a conventional absorbent article 300 having elastics 312 and 318. A first set of elastics 322 having a plurality of first elastics 312 may be provided along the longitudinal side edge 330. A similar first set of elastics 322 may also be provided on the opposing longitudinal side edge 230. A second set of elastics 324 similarly having a plurality of elastics 312 may also be provided along the longitudinal edges 330. Lastly, a third set of elastics 328 consisting of elastics 318 may be provided along the lateral end edge 235.

In this third conventional absorbent article 300, the following product characteristics are emphasized: (a) elastics 312 within first and second set 322, 324 are substantially identical to each other, (b) elastics 312 within the first set 322 are not spaced substantially the same as those in second set 324, and (c) longitudinal side edges 330 are not substantially perpendicular to lateral end edge 335. Consequently this third conventional absorbent article 300 has two standard stretch zones along its side edges 330 with a resulting overall product outline being curved in shape. Said curved shape is illustrated by a difference in length between a lower lateral dimension, L_{L}, and a higher lateral dimension, L_{U}.

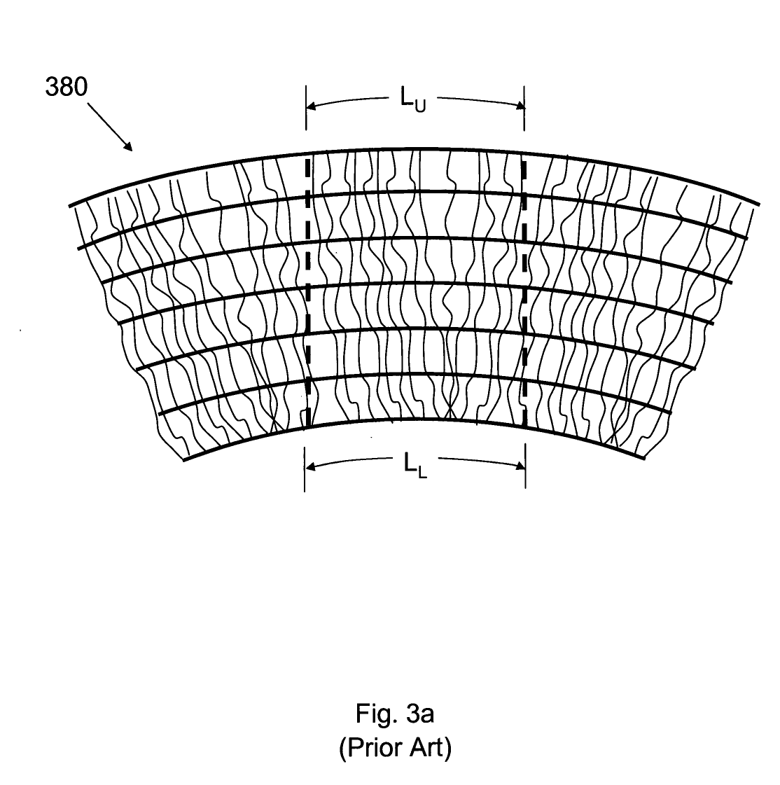

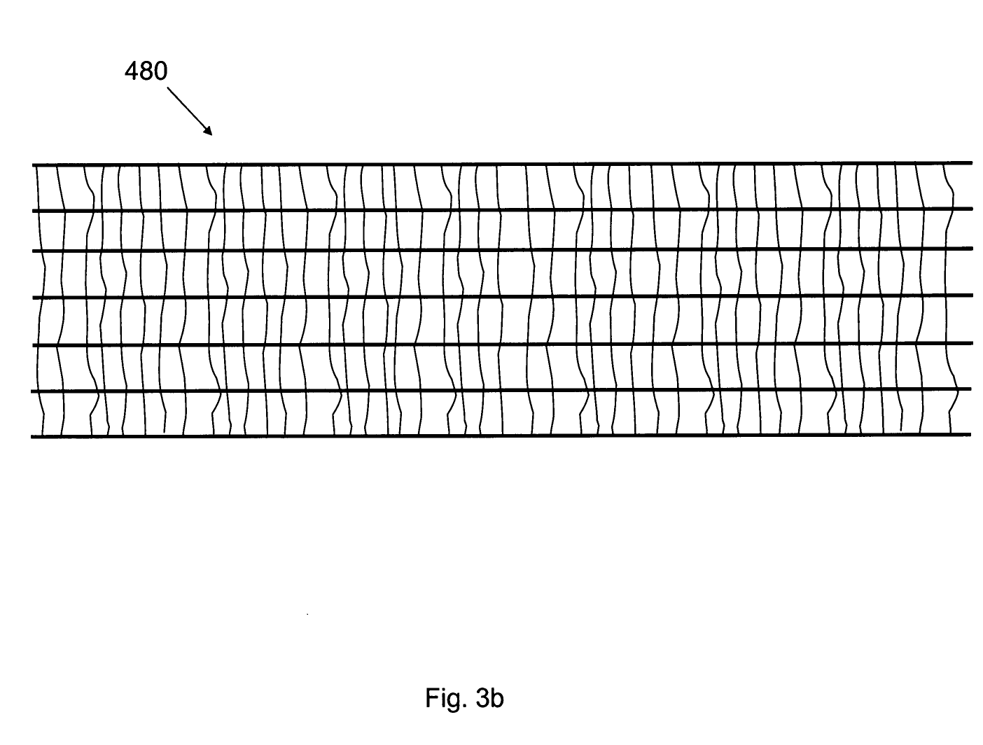

FIG. 3a depicts a portion of a conventional web material 380 used to manufacture absorbent article 200. Web material 380 is shown in a relaxed state, wherein, elastics 212, 214 are retracted to a state of equilibrium with nonwoven material 383 to cause corrugations 385. Because elastics 212 are different from elastics 214, elastics 212 will have a different state of equilibrium than that of elastics 214. Consequently, web material 380 will have a relaxed, curved shape as illustrated by the difference in length between a lower lateral dimension, L_{L}, and a higher lateral dimension, L_{U}. Said conventional material 380 having elastics of differing equilibriums is often difficult to handle on many converting manufacturing processes because of the varying tensions in the web. As a result, the manufacturing process is often unreliable and/or expensive to operate.

In contrast to FIG. 3a, FIG. 3b depicts a portion of an exemplary web material 480 in accordance with the present invention. Web material 480 is shown in a relaxed state, wherein, elastics 412, 414 are retracted to a state of equilibrium with nonwoven material 483 to cause corrugations 485. Despite elastics 412 and elastics 414 being different from one another, both sets of elastics experience substantially the same state of equilibrium. Consequently, web material 480 will have a relaxed, linear shape. Said web material 480 is easier to process and also provides unique product design characteristics. The novel method for achieving said equilibriums will be discussed later.

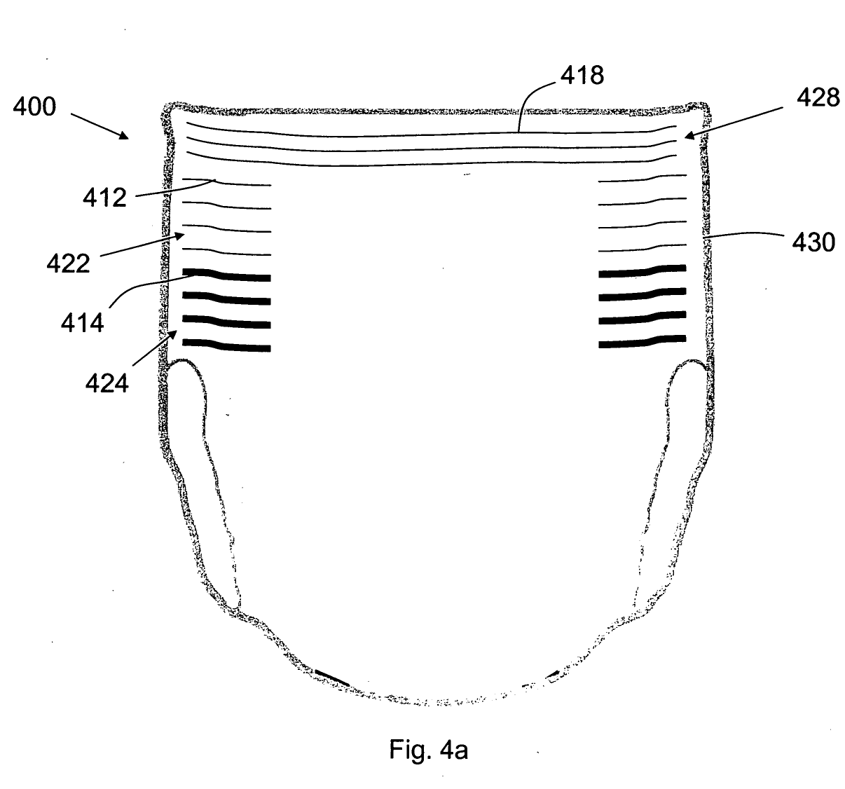

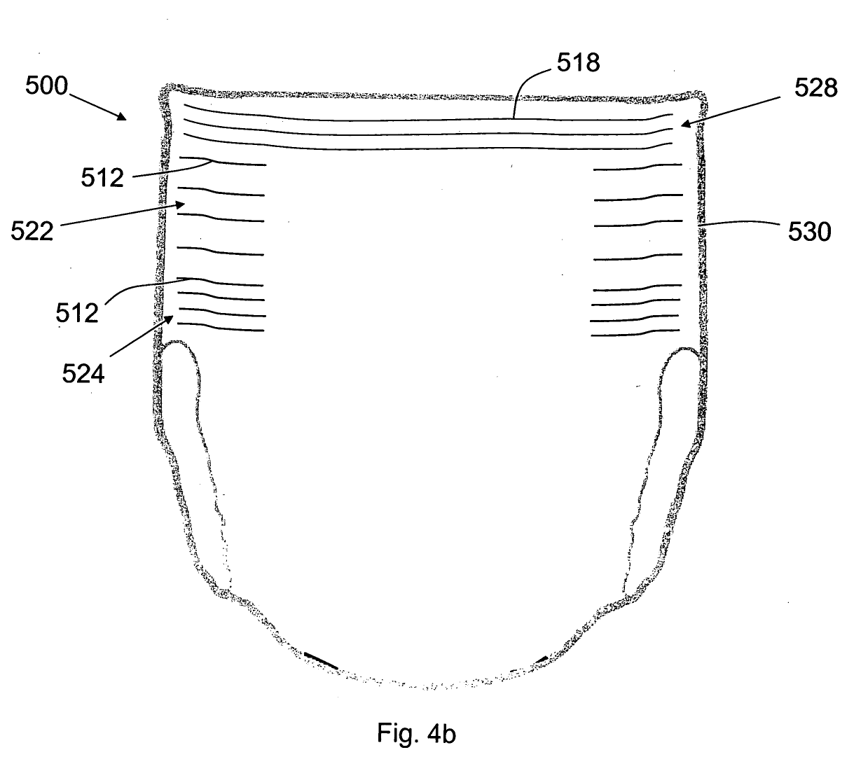

FIG. 4a depicts an exemplary absorbent article 400 in accordance with the present invention. More specifically, absorbent article 400 has elastics 412, 414 and 418. A first set of elastics 422 having a plurality of first elastics 412 may be provided along the longitudinal side edge 430. A similar first set of elastics 422 may also be provided on the opposing longitudinal side edge 430. A second set of elastics 424 having a plurality of second elastics 414 may also be provided along the longitudinal edges 230. Lastly, a third set of elastics 428 consisting of elastics 418 may be provided along the lateral end edge 435.

In this novel absorbent article 400, the following product characteristics are emphasized: (a) first elastics 412 are not substantially identical to second elastics 414, (b) elastics 412, 414 within first and second sets 422, 424 are spaced substantially the same from each other, and (c) longitudinal side edges 430 are substantially perpendicular to lateral end edge 435. Consequently, absorbent article 400 has two distinct stretch zones along its side edges 430 with a resulting overall product outline being linear in shape.

FIG. 4b depicts an exemplary absorbent article 500 in accordance with the present invention. More specifically, absorbent article 500 has elastics 512 and 518. A first set of elastics 522 having a plurality of first elastics 512 may be provided along the longitudinal side edge 530. A similar first set of elastics 522 may also be provided on the opposing longitudinal side edge 530. A second set of elastics 524 similarly having a plurality of elastics 512 may also be provided along the longitudinal edges 530. Lastly, a third set of elastics 528 consisting of elastics 518 may be provided along the lateral end edge 535.

In this novel absorbent article 500, the following product characteristics are emphasized: (a) elastics 512 within first and second set 522, 524 are substantially identical to each other, (b) elastics 512 within the first set 522 are not spaced substantially the same as those in second set 524, and (c) longitudinal side edges 530 are substantially perpendicular to lateral end edge 535. Consequently this third conventional absorbent article 500 has two distinct stretch zones along its side edges 530 with a resulting overall product outline being linear in shape.

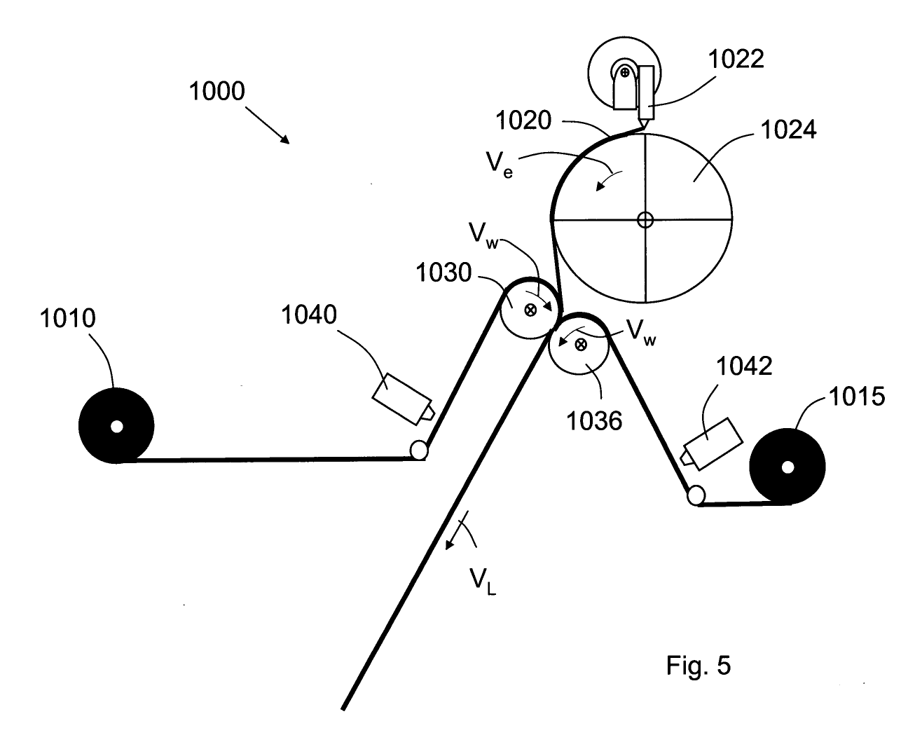

FIG. 5 depicts an exemplary manufacturing process 1000 for making absorbent articles in accordance with the present invention. More specifically, process 1000 includes an elastic 1020 being laminated between a first web of material 1010 and a second web of material 1015. Said webs of materials may be supplied by the unwinding of rolled goods. Subsequently, adhesive from adhesive applicators 1040, 1042 may be applied onto said webs. Next, said webs may be fed about laminating rolls 1030, 1036 prior to the lamination step. Said laminating rolls being rotated at a given velocity and direction as indicated by arrow V_{W}. Elastic 1020 may be extruded from an extruder 1022 onto a chilled drum 1024. Said drum being rotated at a given velocity and direction as indicated by arrow V_{E}. The velocity of said laminating rolls, V_{W}, has a higher value than that amount the velocity of said drum, V_{E}. This velocity difference causes elastic 1020 to be strained prior to the lamination step. This velocity difference also results in a greater amount of web material being laminated than that of the amount of elastics being introduced. This velocity difference may be represented in a speed ratio of V_{W}/V_{E}, wherein the speed ratio is typically greater than 1.

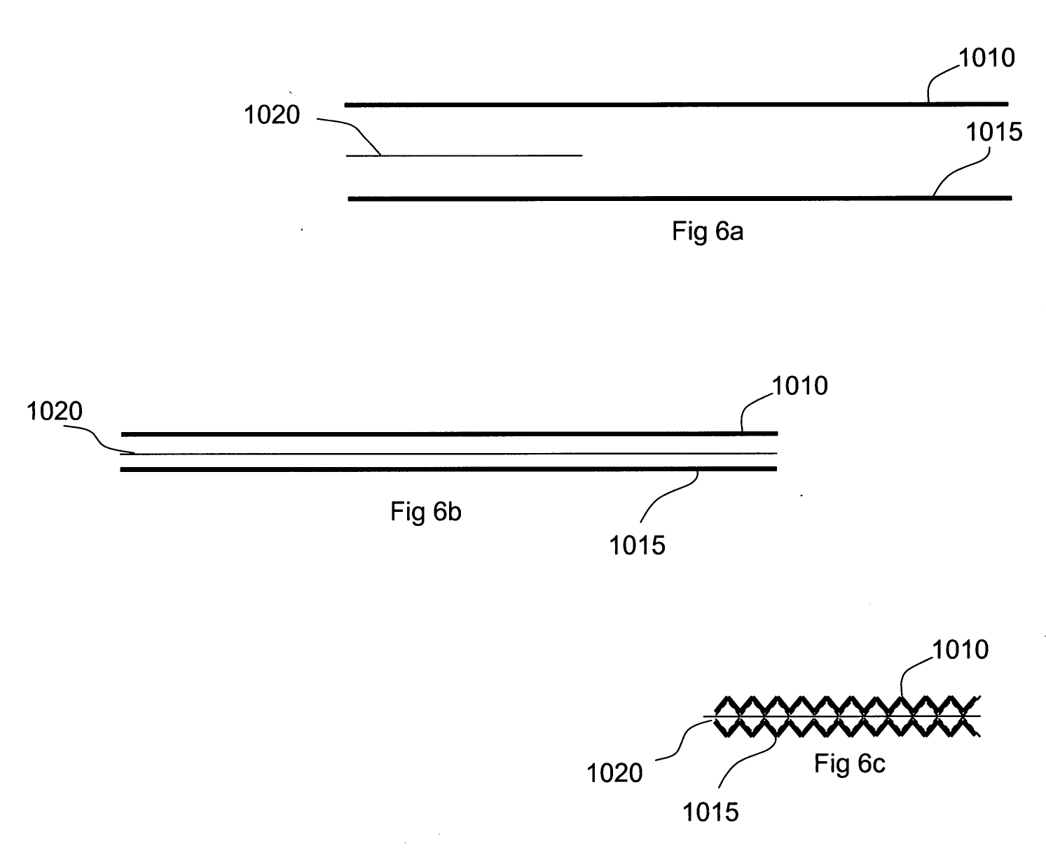

Referring now to FIG. 6a, a first material 1010, second material 1015 and elastic 1020 are shown in a pre-laminated state, wherein their starting lengths are not all equal. More specifically, the first material 1010 and second material 1015 have substantially the same starting length; whereas, elastic 1020 is shorter than said materials. For example, assuming a speed ratio (V_{W}/V_{E}) equal to 4.0, a corresponding feed length of the first and second materials will be approximately 400 cm and a corresponding feed length of the elastic will be approximately 100 cm. Given that less of the elastic is fed into the process 1000, said elastic will need to be stretched/strained prior to lamination between laminating rolls 1030, 1036 in order to create the laminate 1021 of FIG. 6b. Once laminate 1021 is formed and allowed to relax, the elastic 1020 causes first and second materials 1010, 1015 to corrugate as shown in FIG. 6c.

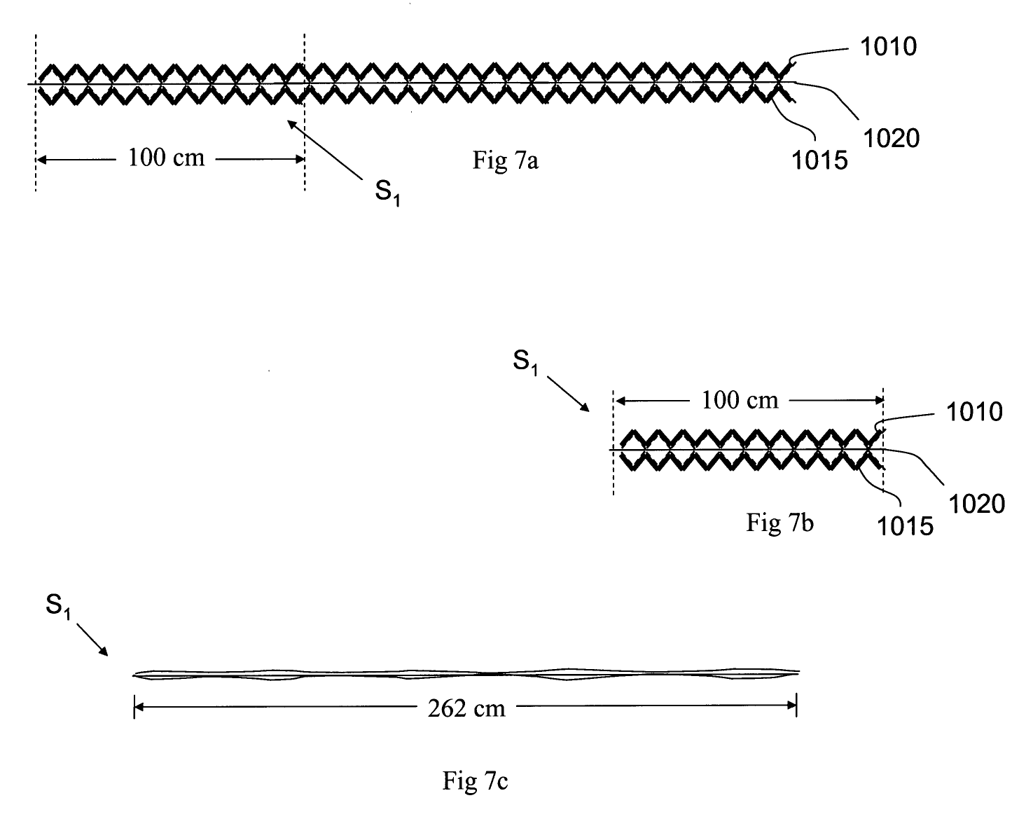

Now that laminate 1021 has been created, the equilibrium properties of said laminate may be determined. Referring now to FIG. 7a, laminate 1021 is shown having a laminate sample 1022 removed at a relaxed length of 100 cm. FIG. 7b shows said laminate sample 1022 (with first material 1010, second material 1015 and elastic 1020 being identified) at a relaxed length of 100 cm. FIG. 7c shows laminate sample 1022 being stretched until the corrugations within first and second materials are substantially flattened.

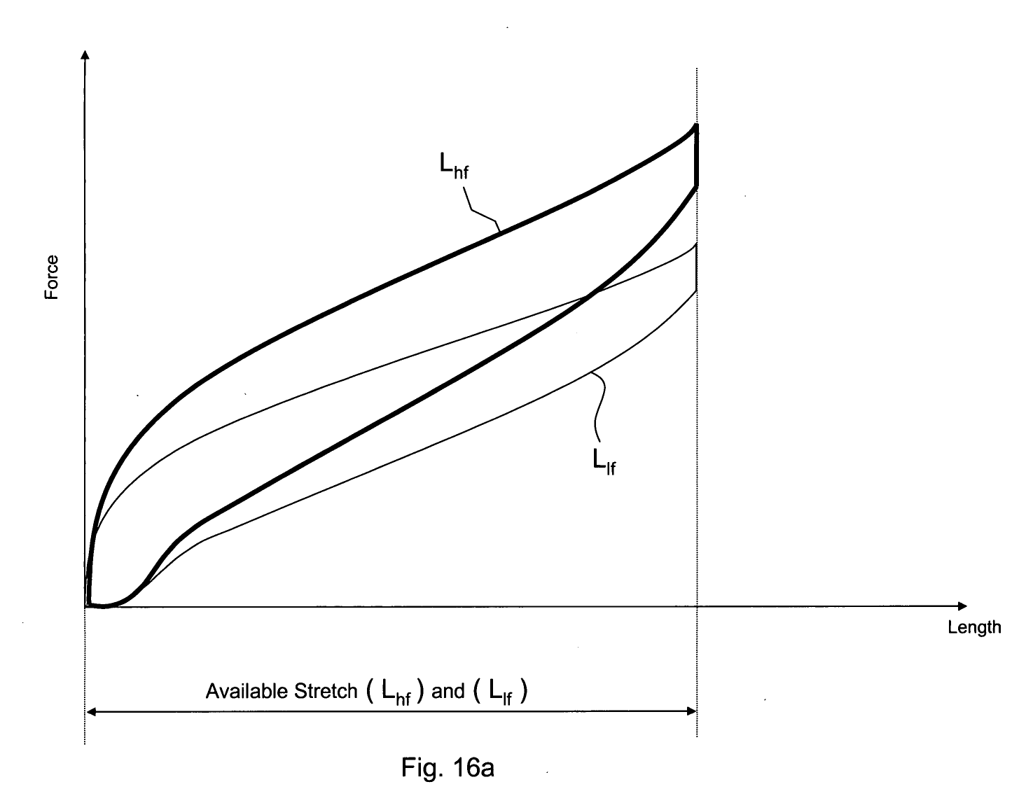

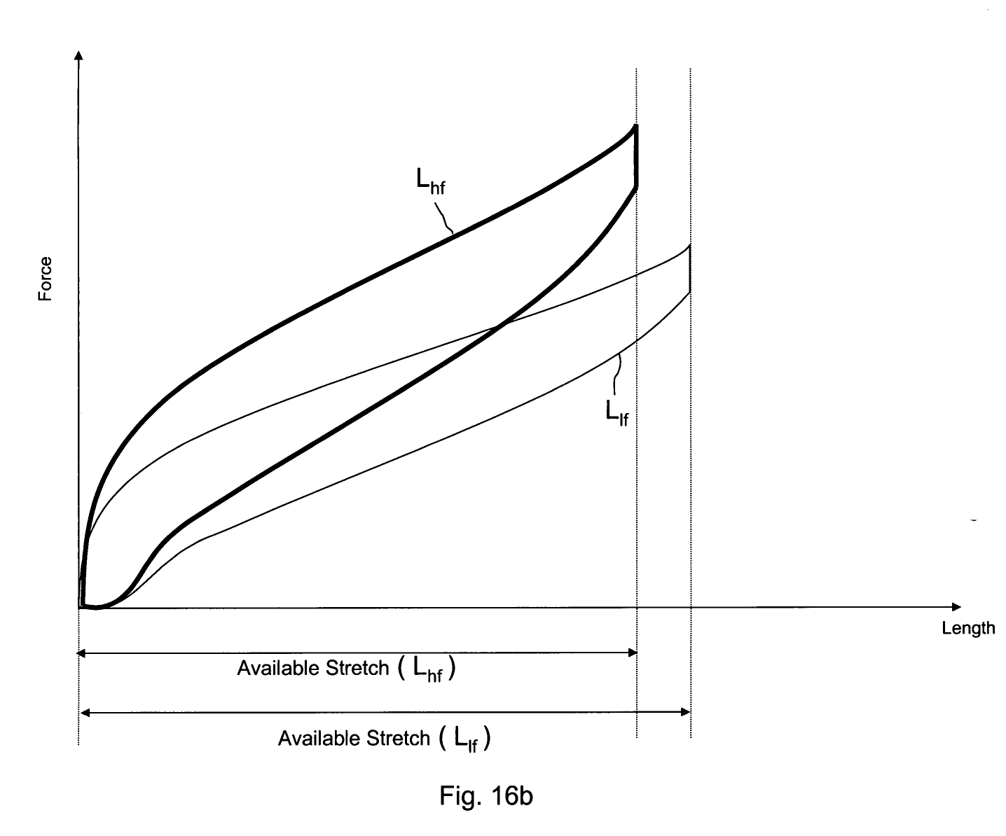

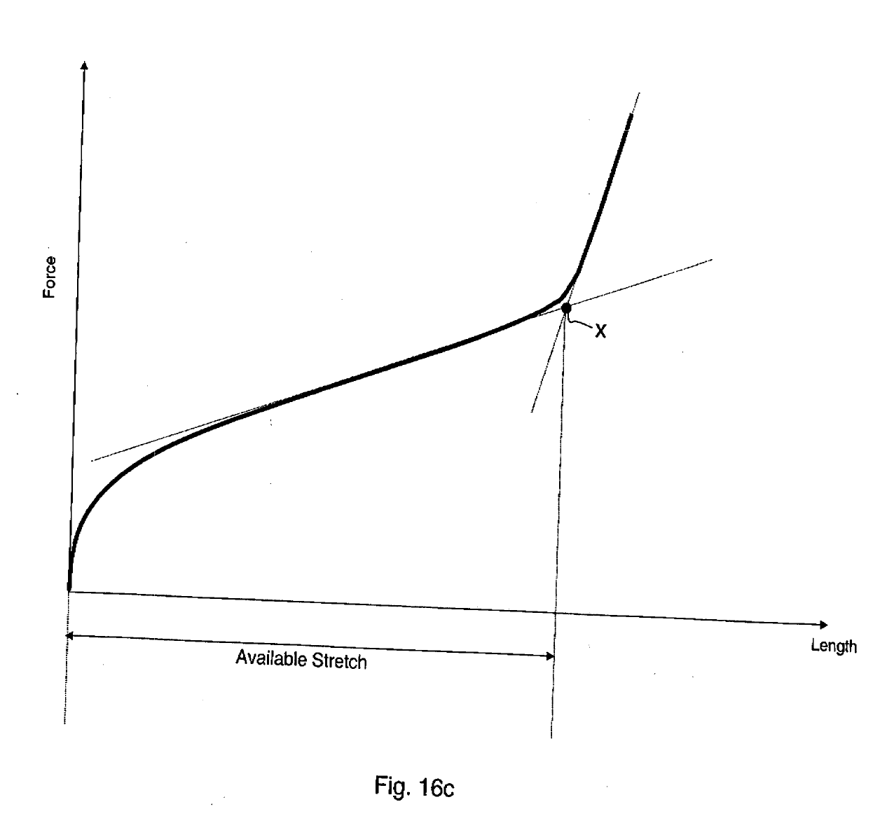

When the first and second materials are substantially flattened a sudden progressive force incline in the extension cycle of the stress-strain curve occurs. The extension force of first and second materials starts adding to the extension force of the elastics, beginning at the point where first and second materials are substantially flattened, causing the curve to incline progressively. FIG. 16c characterizes the stretched length of the laminate at point x where the slopes of the curve (shown as dotted lines), prior and past the progressive force incline, intersect. Stress-strain measurements as discussed later in the Test Method paragraph would typically stop the laminate extension at point x, where first and second materials are substantially flattened.

The stretched laminate sample 1022 is then measured at an exemplary stretched length of 342 cm.

With the above measurements, the following calculations may be performed in order to determine the corresponding length of the elastic when the laminate is at equilibrium:

$$P . S . ( process strain ) = ( {V}_{W} / {V}_{E} ) = ( 400 / 100 ) = 4.0$$

$$\begin{matrix}A / S . ( available strain ) = \frac{stretched length of laminate sample}{relaxed length of the laminate} \\ = \frac{.342 cm}{100 cm} \\ = 3.42\end{matrix}$$

$$\frac{P . S .}{A . S .} = \frac{4.0}{3.42} = 1.17$$

$$\begin{matrix}( Relaxed length of the laminate ) * ( P . S . / P . A . ) = 100 cm * 1.17 \\ = 117 cm\end{matrix}$$

In summary, with the above exemplary velocities, the actual length of the elastic within the relaxed laminate sample 1022 is equal to 117 cm.

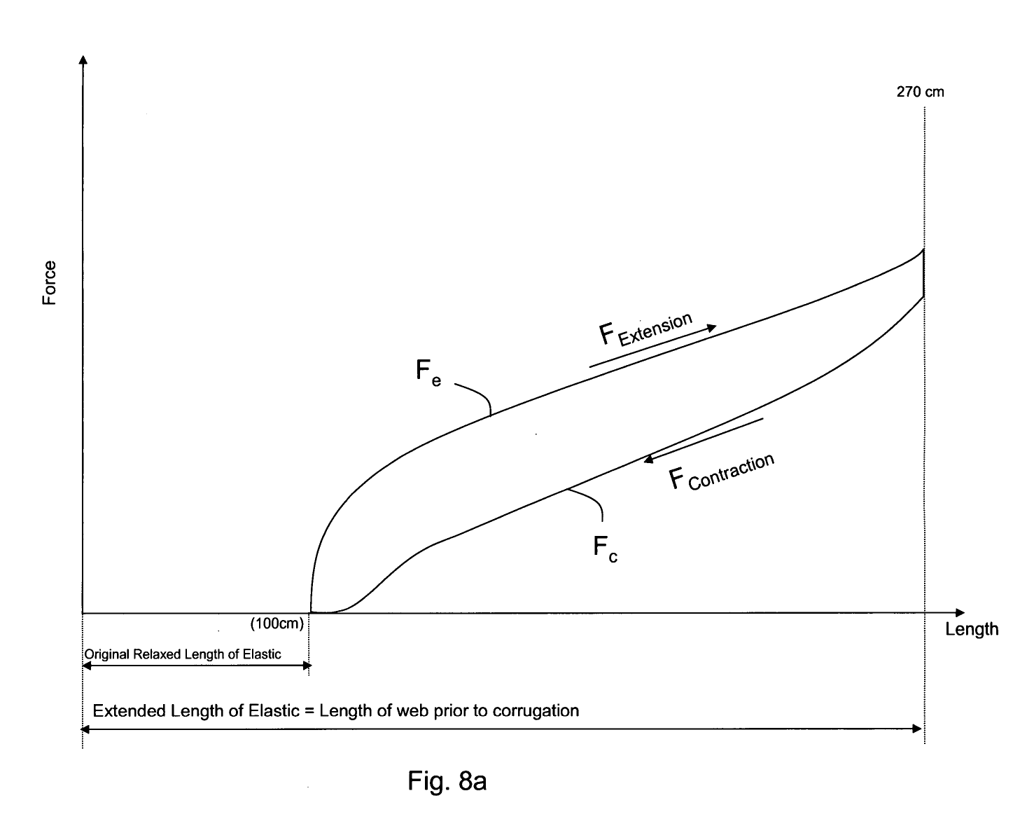

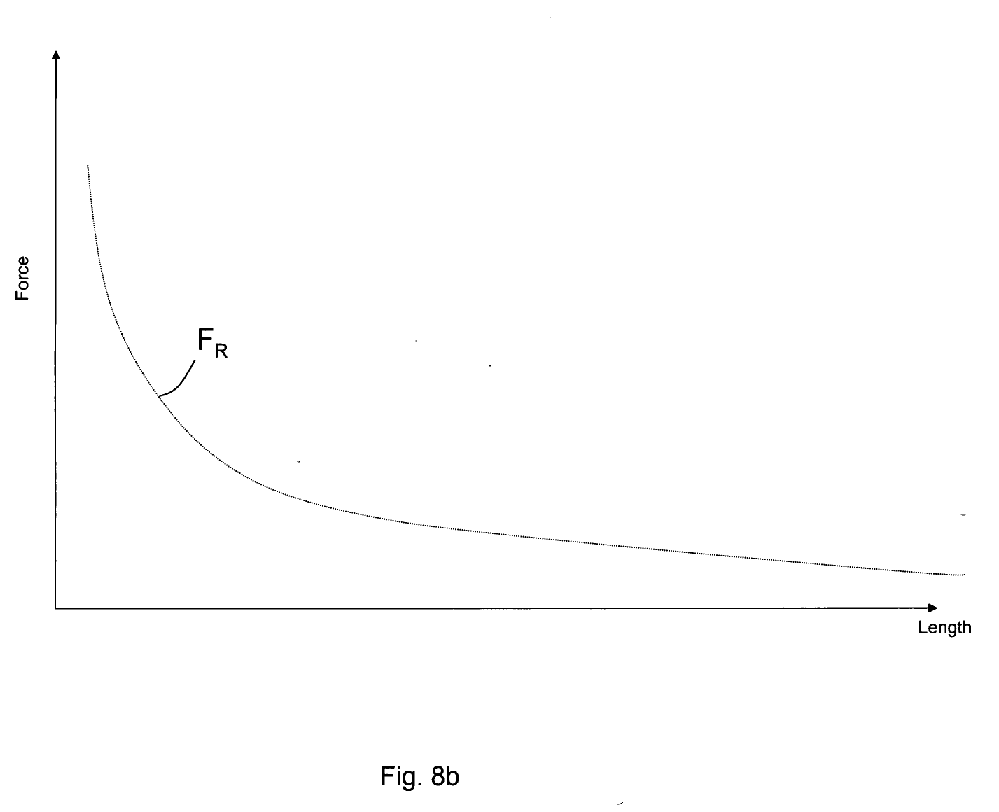

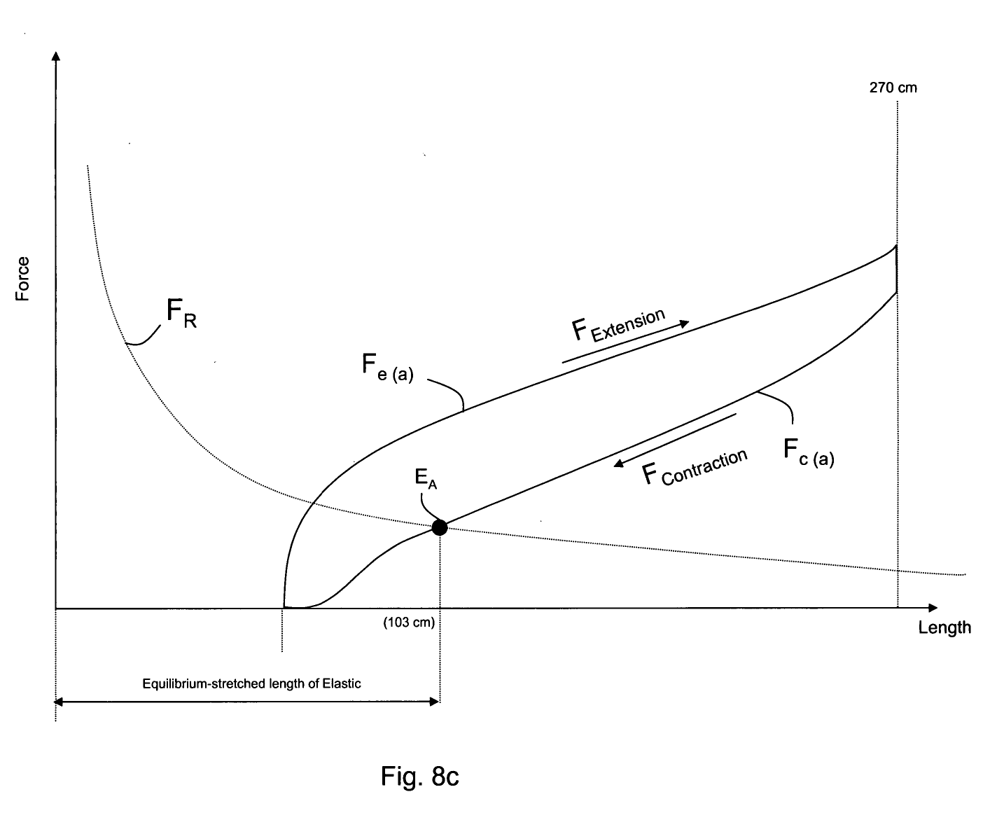

Now let's look at these values and calculations within a series of stress-strain curves. Referring now to FIG. 8a, an exemplary, conceptual stress-strain curve is shown for a single elastic 1022 (or multiple elastics having homogenous properties) having an original relaxed length of 100 cm. This exemplary elastic is shown to have substantially retracted to its original relaxed length after being extended to an exemplary stretched length of 400 cm (i.e., length of first and second materials prior to corrugation). The upper portion of the stress-strain curve, identified as Fₑ, shows the data during the extending (i.e., stretching) of the elastic; conversely, the little or portion of the stress-strain curve, identified as F_{c}, shows the data during contraction of the elastic. This chart only shows the stretch properties of the elastic, not the entire laminate.

Referring now to FIG. 8b, force F_{R} depicts the amount of resistive force exerted by the web materials (i.e., first and second materials 1010, 1020) in an effort to resist formation of corrugations. Force F_{R} is a function of the amount of corrugation and the material's mechanical/stretch properties. Similarly, this chart only shows the stretch properties of the web material, not the entire laminate.

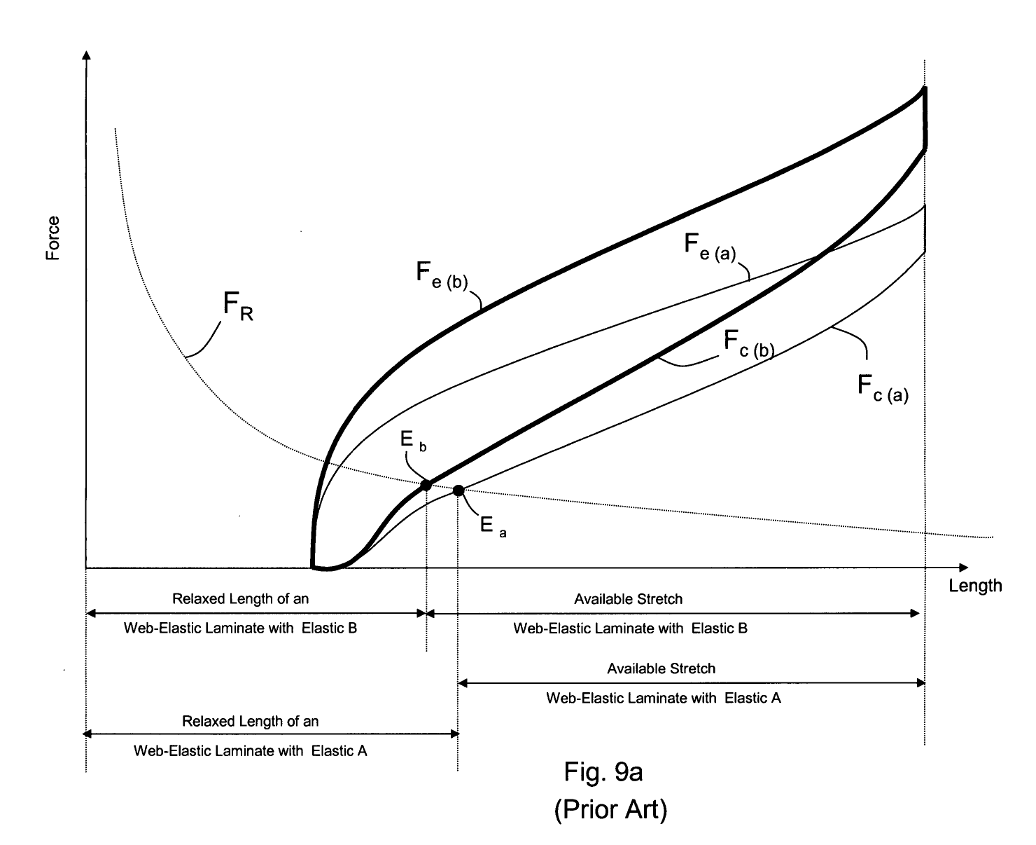

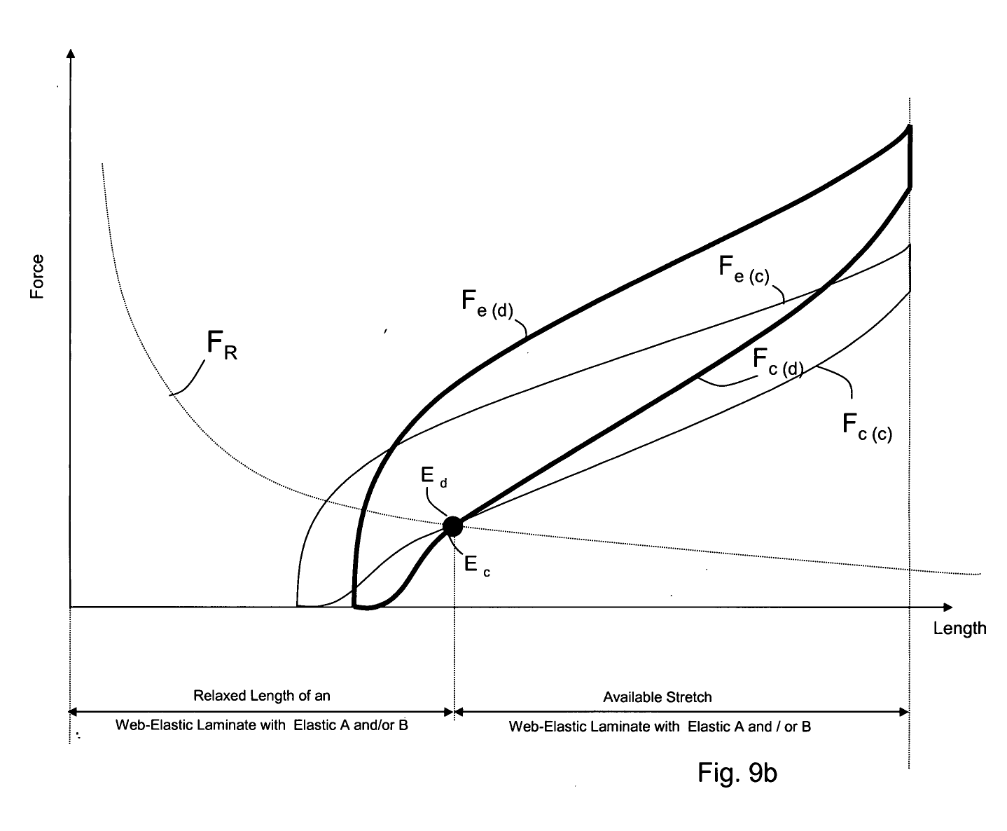

Referring now to FIG. 8c, an exemplary, conceptual stress-strain curve is shown for laminate sample 1022. This particular laminate has a single elastic 1022 (or multiple elastics having homogeneous properties) and therefore only has a single elastic curve made of Fe(a) and F_{c(b)}. An equilibrium point, E_{A}, is identified as the intersection of the elastic curve and the web material curve. At said equilibrium point, the elastic and web material are exerting equal resistive force upon each other. Furthermore, at said equilibrium point, the elastic has an equilibrium-stretched length of 117 cm within said laminate sample 1020.

Whereas FIG. 8c provides a conceptual stress-strain curve for laminate having a single elastic, FIG. 9a provides a conceptual stress-strain curve for a laminate having two distinct elastics. More specifically, extending forces Fe(a), Fe(b) and contracting forces F_{c(a)}, F_{c(b)} for a first elastic 1020a and a second elastic 1020b, respectively, are shown. Because said first elastic 1020a has different mechanical/stretch properties than that of second elastic 1020b, these two elastics have differing equilibrium points (Eₐ and E_{b}, respectively) with the retracted force, Fr, of the same web material. In this exemplary model, the second elastic 1020b is stronger than the first elastic 1020a as illustrated by the greater amount of contraction. Thus, the second elastic 1020b will corrugate the web material more than the first elastic 1020a. Consequently, when first and second elastics are incorporated into the same laminate, the resulting laminate will be curve in shape as shown in FIG. 3a. This exemplary stress-strain curve is typical of the problems experienced within the prior art.

In contrast, FIG. 9b provides an exemplary, conceptual stress-strain curve for the present invention. More specifically, extending forces F_{e(c)}, F_{e(d)} and contracting forces F_{c(c)}, F_{c(d)} for a first elastic 1020c and a second elastic 1020d, respectively, are shown. Despite said first elastic 1020c having different mechanical/stretch properties than that of second elastic 1020d, these two elastics have substantially the same equilibrium points (E_{c} and E_{d}, respectively) with the retracted force, Fr, of the same web material. Thus, the first and second elastics will similarly corrugate the web material. Consequently, when first and second elastics are incorporated into the same laminate, the resulting laminate will be linear in shape as shown in FIG. 3b. Methods/processes for achieving substantially the same equilibrium points (e.g., E_{c} and E_{d}) will be discussed below.

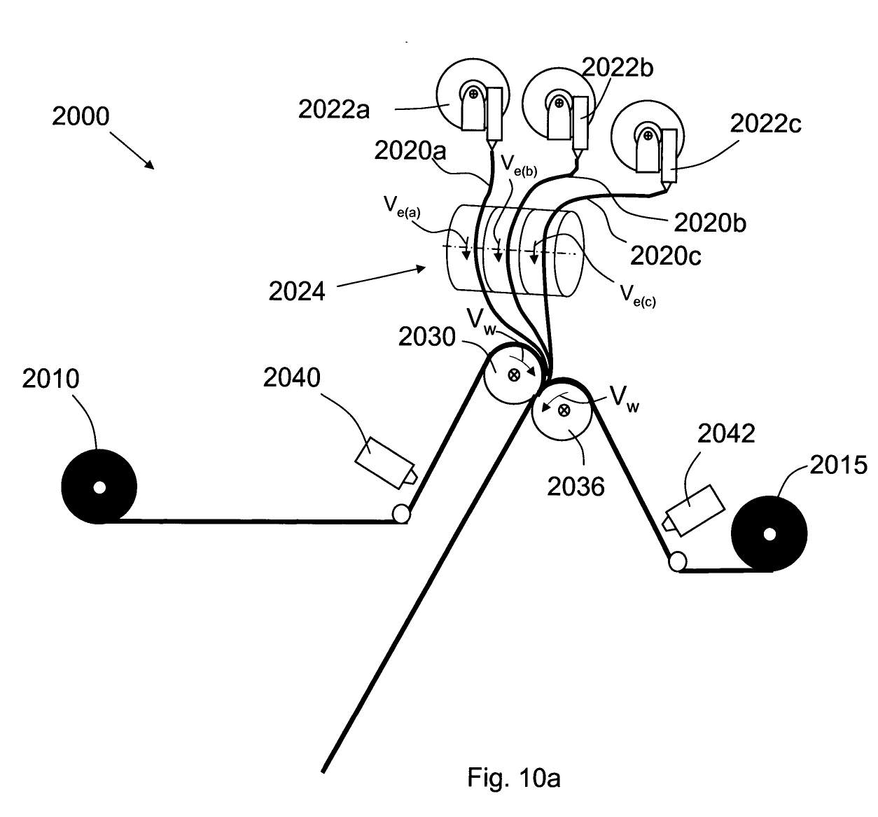

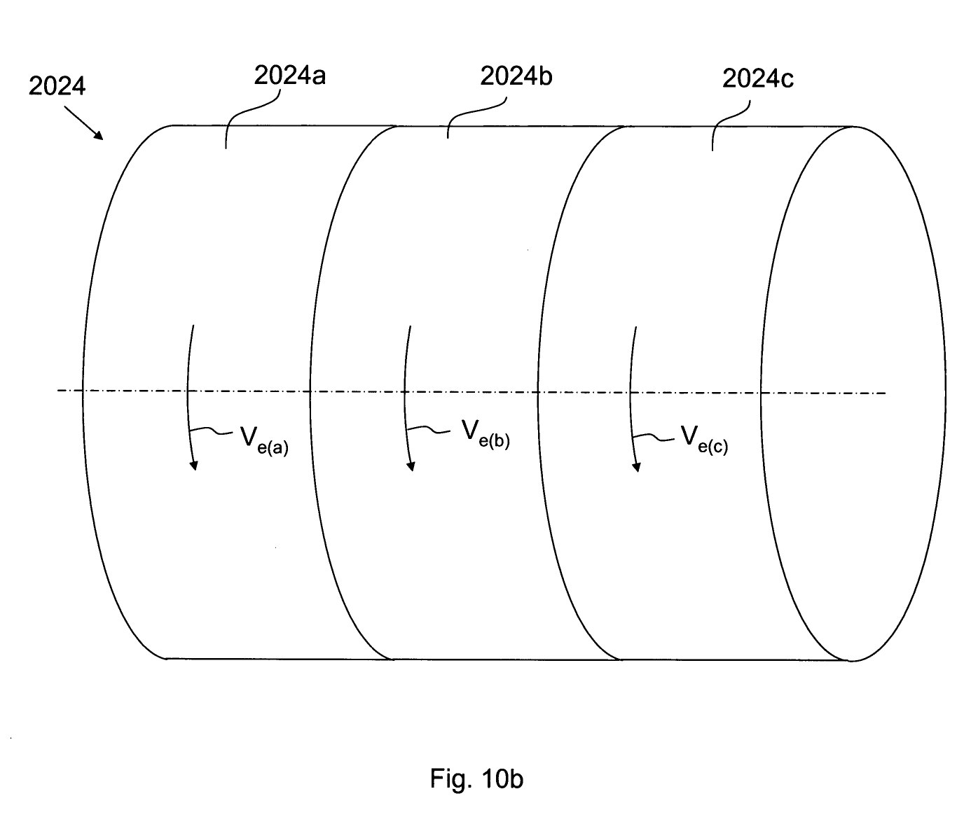

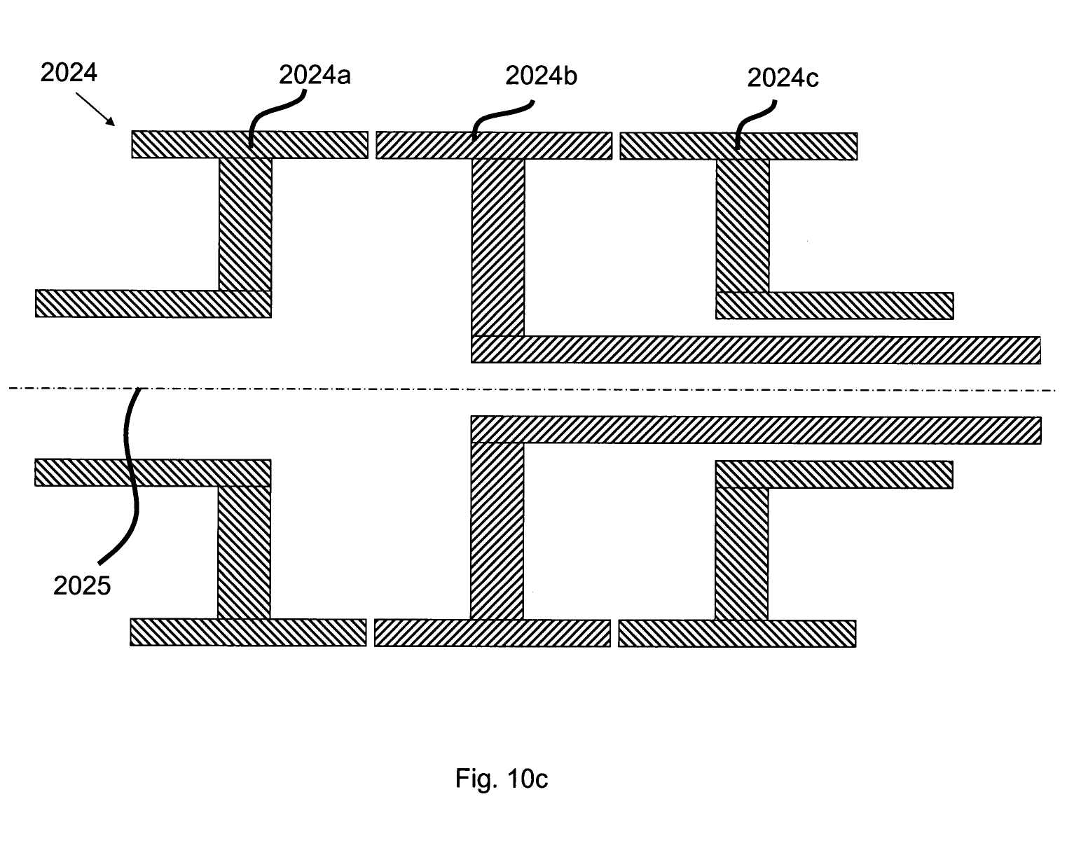

FIGS. 10a-10c depict an exemplary manufacturing process 2000 for making absorbent articles in accordance with the present invention. In this particular example, process 2000 includes a first elastic 2020a, second elastic 2020b and a third elastic 2020c being laminated between a first web of material 2010 and a second web of material 2015. Said webs of materials may be supplied by the unwinding of rolled goods. Subsequently, adhesive from adhesive applicators 2040, 2042 may be applied onto said webs. Next, said webs may be fed about laminating rolls 2030, 2036 prior to the lamination step. Said laminating rolls being rotated at a given velocity and direction as indicated by arrow V_{W}. Elastics 2020a, 2020b, 2020c may be extruded from extruders 2022a, 2022b, 2022c, respectively, onto a chilled drum 2024. One skilled in the art, however, would appreciate that said elastics may be extruded from a single extruder that provides different flow amounts in different regions.

In this particular example, drum 2024 is shown having three distinct rotating surfaces 2024a, 2024b, 2024c each being rotated at a given velocity and direction as indicated by arrows V_{E(a),} V_{E(b),} V_{E(c)}, respectively. The velocity of laminating rolls 2030, 2036, V_{W}, has a higher value than that amount the velocity of said drum rotating surfaces, V_{E(a),} V_{E(b),} V_{E(c)}. These velocity differences cause elastics 2020a, 2020b and 2020c to be strained at different strain rates prior to the lamination step. Importantly, these different strain rates produce elastics having differing elastic properties. Additionally, these velocity differences result in a greater amount of web material being laminated than that of the amount of elastics being introduced. Lastly, these velocity differences may be represented in a speed ratio of V_{W}/V_{E(a)}, V_{W}/V_{E(b)} and V_{W}/V_{E(c)} wherein the speed ratios are typically greater than 1.

Referring now to FIG. 10c, a cross-sectional view of drum 2024 is shown. More specifically, the three rotating surfaces 2024a, 2024b, 2024c are shown to be distinct moving parts. One exemplary method for providing distinct rotating surfaces is the use of adjoining drums having co-axial shafts. Each shaft may be rotated at different speeds in order to achieve differing velocities V_{E(a),} V_{E(b),} and V_{E(c)}.

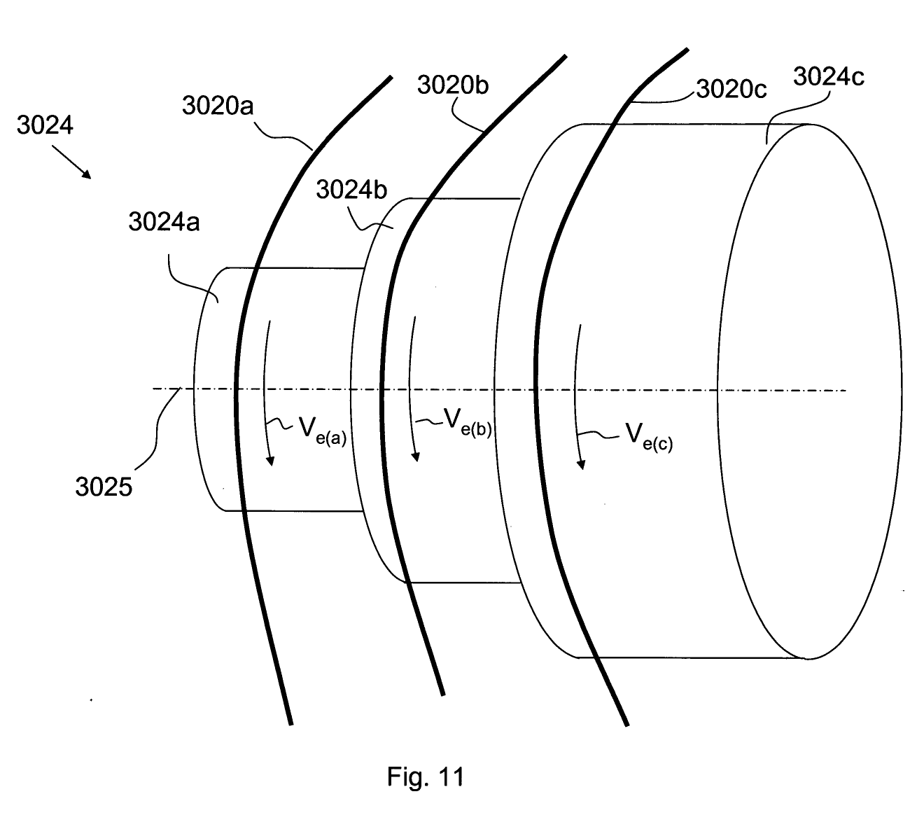

FIG. 11 depicts another apparatus 3024 for providing three distinct rotating surfaces 3024a, 3024b, 3024c each being rotated at a given velocity and direction as indicated by arrows V_{E(a),} V_{E(b),} V_{E(c)}, respectively. In this exemplary embodiment, the differing velocities V_{E(a),} V_{E(b),} and V_{E(c)} are achieved by changing the diameter of each drum segment. In this way, each drum segment may be rotated about the same shaft at the same shaft rotational speed, yet still achieve differing surface velocities in accordance with the present invention. One skilled in the art, however, would appreciate that the drum segments need not be similarly shafted.

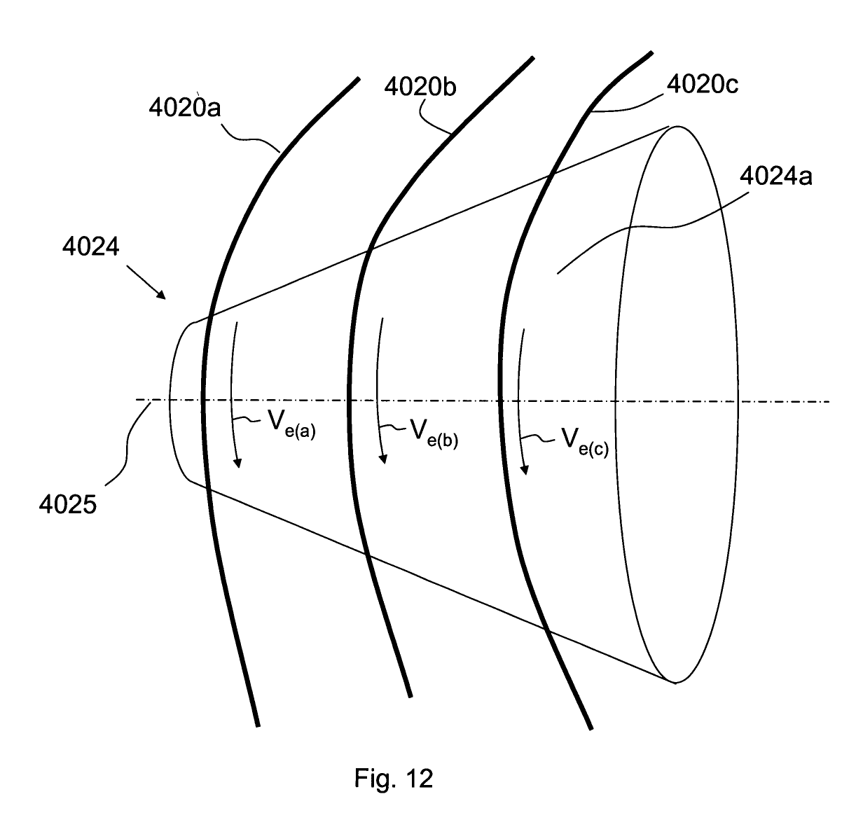

FIG. 12 depicts yet another apparatus 4024 for providing distinct rotating surfaces. Apparatus 4024 may be constructed in a substantially conical shape having a single rotating surface 4024a and being rotated about a single shaft or axis 4025. In this way, the conical-shape has a changing diameter so as to provide a variety of differing surface velocities. For example, elastics 4020a, 4020b and 4020c are being rotated at a differing velocity as indicated by arrows V_{E(a),} V_{E(b),} V_{E(c)}, respectively.

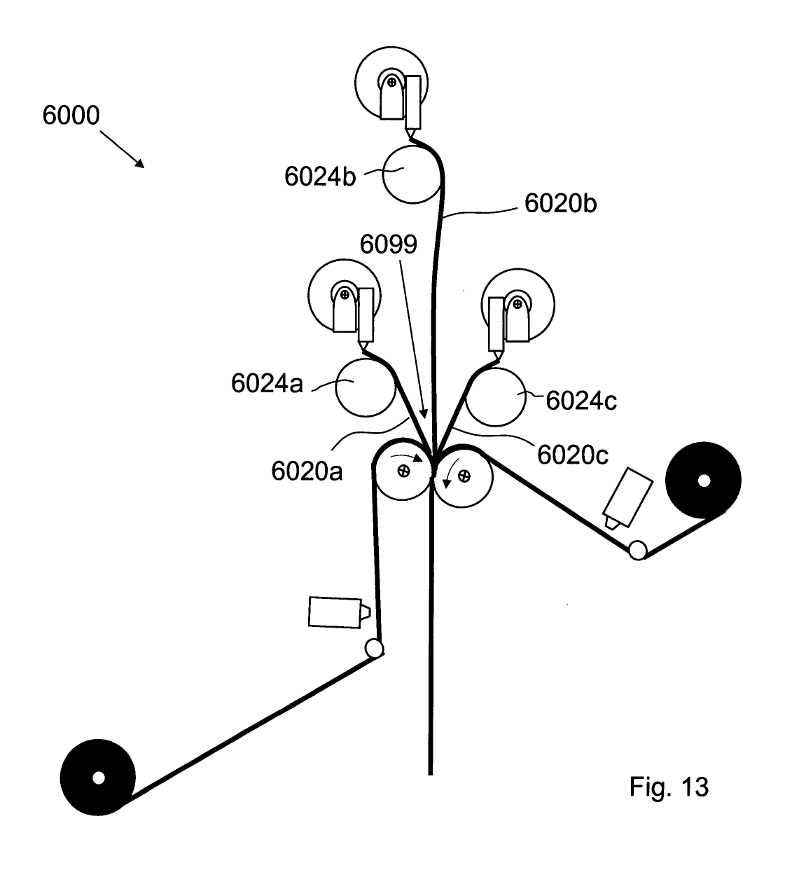

While FIGS. 10-12 provide novel coaxial designs of the rotating surfaces, one skilled in the art would appreciate that the novel subject product may be manufactured by non-coaxial apparatuses. For example, FIG. 13 depicts a non-coaxial apparatus 6000 similar to FIG. 10a except that elastics 6020a, 6020b, 6020c are extruded onto separate chilled drums 6024a, 6024b and 6024c, respectively. Said chilled drums may be rotated at different surface speeds. Said elastics are subsequently feed into the same combining nip.

It should be appreciated, however, that the coaxial designs of FIGS. 10-12 provide the option to minimize the unsupported strand length between drum and combining nip as compared to the larger span between drum 6024b and combining nip 6099. Minimizing the unsupported elastic strand length is detailed in copending application U.S. Ser. No. 10/836,944, filed on Apr. 30, 2004 to Schneider et al. For example, it is stated that it is preferable that the first roller [herein, laminating roll] is positioned as close to the cooled surface of the drum as possible without actually making contact. The actual measured distance separating the two depends upon the sizes of the drum and the first roller. For instance, for a drum diameter of 1 meter and a first roller diameter of 150 mm, the distance between the cooled surface of the drum and the first roller can range from approximately 0.5 mm to about 5 mm. The corresponding length of the span of unsupported strands can range from about 18 mm to about 75 mm. For smaller size drums, the length of the span of unsupported strands can be shorter. For instance, a 0.5 meter diameter drum with a 150 mm first roller 130 can enable the first roller to be positioned as close as 1 mm to the cooled surface of the drum and limit tie length of the span of unsupported strands to about 22 mm. The first roller receives the plurality of strands near the cooled surface of the drum, minimizing the span of unsupported strands between the cooled surface of the drum and the first roller. Preferably, the plurality of strands transfers from the cooled surface of the drum to the first roller such that the strands are approximately tangent to both the cooled surface of the drum and the surface of the first roller and the length of the span of unsupported elastomeric strands is minimal, ranging between about 10 mm and about 200 mm. Preferably, the length of the span of unsupported elastomeric strands during the transfer ranges between about 20 mm and about 50 mm. By minimizing the length of the span of unsupported strands during the transfer, the elastomeric strands can be transferred to the first roller in a controlled distribution where the distance measured between any two adjacent strands varies 30% or less from the point of extrusion to the point of lamination. For instance, if the original spacing at the extruder is set at 1 mm, the spacing between any two adjacent strands will range between 0.7 mm to 1.3 mm.

### EXAMPLES

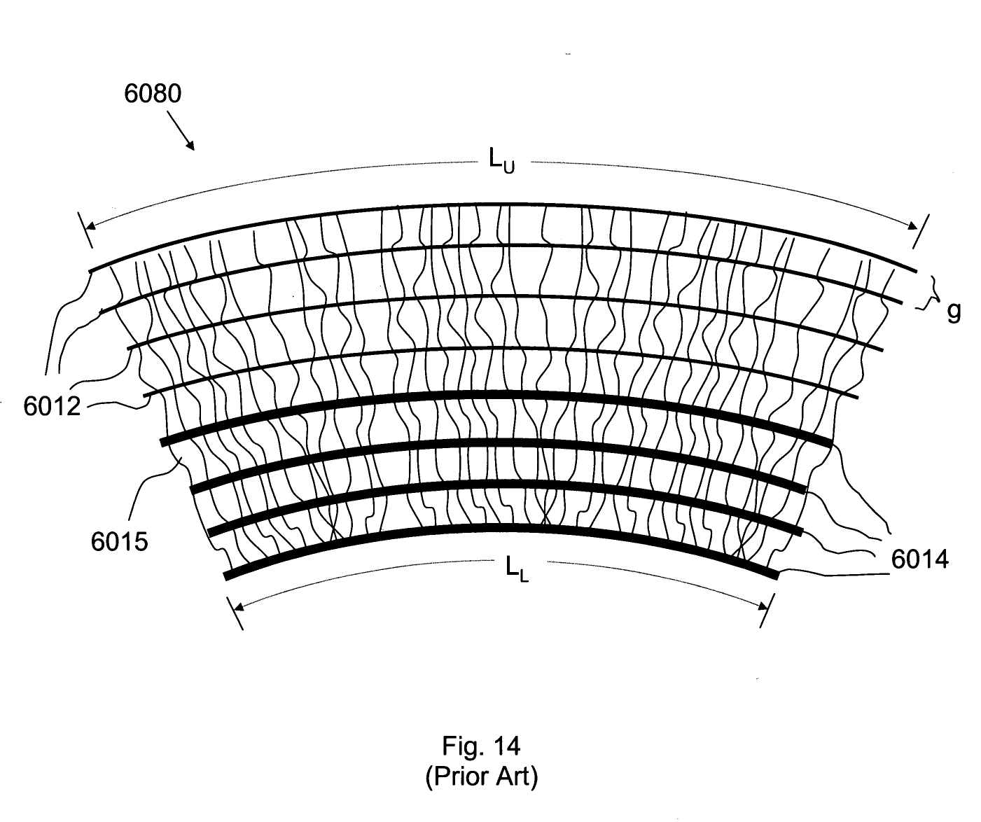

FIG. 14 depicts an exemplary laminate 6080 within the prior art. Laminate 6080 may be constructed from elastics (e.g., made of a block copolymer supplied by Kuraray under the trade name KL 2014) tensioned and sandwiched between two layers of 10 gsm SMS polypropylene nonwoven (e.g., supplied by Avgol). An adhesive (not shown) may be used to laminate the two layers together (e.g., 3 gsm; Findley H2031). Upon relaxation of the tension in the elastics (e.g., 6012, 6014), the nonwoven will form gathers 6015.

More specifically, laminate 6080 may be constructed of a series of first elastics 6012 and a series of second elastics 6014. Elastics 6012 have an elastic basis weight of about 20 gsm when measured in the relaxed laminate. Elastics 6014 have an elastic basis weight of about 70 gsm when measured in the relaxed laminate. Elastics 6012, 6014 are similarly spaced apart 2.5 mm from each other.

Assuming that elastics 6012 were produced under a process strain of 4.0 (i.e., elastic was originally stretched to four times its original length during the lamination process), the resulting laminate would contract by a factor of 3.42 (i.e., available strain) to a relaxed-equilibrium length (L_{U}) of approximately 117.0 cm. Assuming that elastics 6014 were produced under the same process strain of 4.0, the resulting laminate would contract by a factor of 3.72 to a relaxed-equilibrium length (L_{L}) of approximately 107.5 cm. Since elastics 6014 have a greater basis weight than elastics 6012, it should be expected that elastics 6014 would contract more than elastics 6012, thus their corresponding relaxed-equilibrium length would also be shorter. Consequently, laminate 6080 is non-linear in shape.

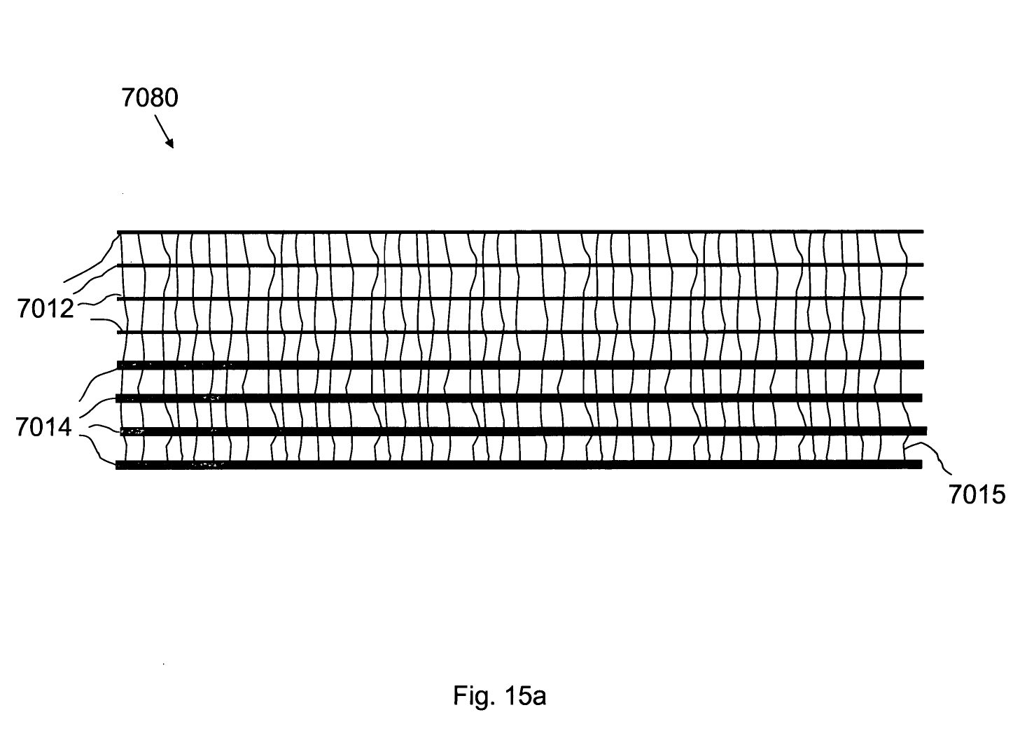

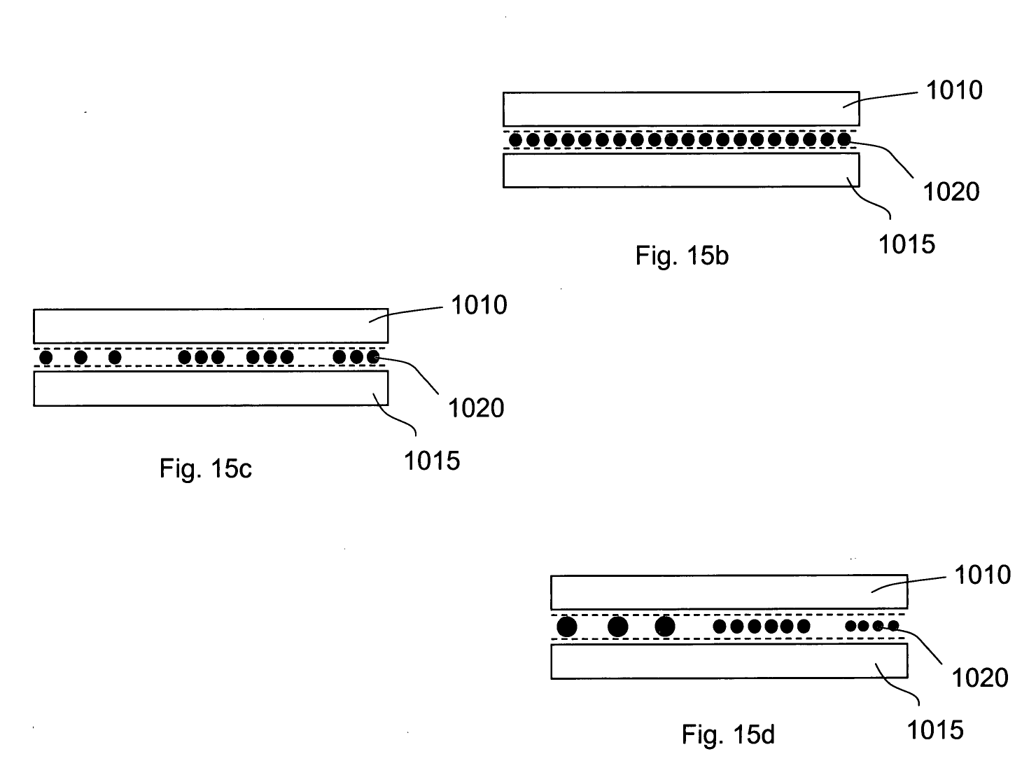

FIG. 15a depicts an exemplary laminate 7080 made in accordance with the present invention. Assuming a similar laminate structure as that described in FIG. 14, wherein laminate 7080 may be made of elastics (e.g., made of a block copolymer supplied by Kuraray under the trade name KL 2014) tensioned and sandwiched between two layers of 10 gsm SMS polypropylene nonwoven (e.g., supplied by Avgol). An adhesive (not shown) may be used to laminate the two layers together (e.g., 3 gsm; Findley H2031). Upon relaxation of the tension in the elastics (e.g., 7012, 7014), the nonwoven will form gathers 7015.

Assuming that elastics 7012 were produced under a process strain of 4.0 (i.e., elastic was originally stretched to four times its original length during the lamination process), the resulting laminate would contract by a factor of 3.42 (i.e., available strain) to a relaxed-equilibrium length (L_{U}) of approximately 117.0 cm. Assuming that elastics 7014 were produced under a different process strain equal to 3.93, the resulting laminate would contract by a factor of 3.42 to a relaxed-equilibrium length (L_{L}) of approximately 117.0 cm. Consequently, laminate 7080 is substantially linear in shape.

In order to achieve a lower process strain for elastics 7014, the velocity of the chilled drum, V_{E}, may be increased while keeping the velocity of the lamination rolls, V_{W}, at its original speed. In order to maintain the same basis weight (e.g., 70 gsm), more elastic material is extruded from extruder 1022.

FIG. 15b depicts an exemplary configuration of a laminate in accordance with the present invention, wherein the elastics 1020 have substantially the same diameter and spacing but have varying elastic properties (e.g., different material type, different stretch properties). Said elastics are laminated between a first web material 1010 and a second web material 1020. This ordinarily curved laminate configuration may be made to be substantially linear by use of the present novel approach.

FIG. 15c depicts another exemplary configuration of a laminate in accordance with the present invention, wherein the elastics 1020 have substantially the same diameter but have varying spacing. Said elastics are laminated between a first web material 1010 and a second web material 1020. This ordinarily curved laminate configuration may be made to be substantially linear by use of the present novel approach.

FIG. 15c depicts yet another exemplary configuration of a laminate in accordance with the present invention, wherein the elastics 1020 have substantially the same spacing but have varying diameters. Said elastics are laminated between a first web material 1010 and a second web material 1020. This ordinarily curved laminate configuration may be made to be substantially linear by use of the present novel approach.

### Test Method

Referring back to FIG. 9a, the prior art teaches a laminate having at least two distinct elastics having substantially different equilibrium points. Consequently, the relaxed lengths and available stretch lengths between said elastics will be different; thus resulting in a substantially non-linear-shaped laminate. In contrast, referring back to FIG. 9b, the present invention teaches a laminate having at least two distinct elastics having substantially the same equilibrium points. Consequently, the relaxed lengths and available stretch lengths between said elastics will be substantially the same; thus resulting in a substantially linearly-shaped laminate.

Standard, industry-wide test methods may be used to produce the necessary stress-strain curves. Such acceptable test methods include the use of EDANA 20.2-89 and/or ASTM D5035-95. In performing said tests on a product incorporating the present invention, several laminate samples should be cut from different stretch regions. The sample may have an exemplary length and width of 2.54 cm×2.54 cm. The present invention is deemed to be practiced when a first laminate sample from a first stretch region (e.g., lower force sample, L_{1f}) and a second laminate sample from a second stretch region (e.g., higher force sample, L₁ₕ) exhibit a different stress-strain curve but have the same amount of available stretch, as conceptually depicted in FIG. 16a. In contrast, the present invention is deemed to not be practiced when the first and second samples have different available stretch values, as conceptually depicted in FIG. 16b.

FIG. 16c characterizes the stretched length of the laminate at point x where the slopes of the curve (shown as dotted lines), prior and past the progressive force incline, intersect. Stress-strain measurements as discussed herein in the Test Method paragraph would typically stop the laminate extension at point x, where first and second materials are substantially flattened.

### Product Applications

The novel laminate of the present invention may find practical application in a multitude of consumer products. As mentioned earlier, for example, this novel laminate may be used in the construction of a disposable diaper. For instance, this novel laminate may provide at least two distinct stretch zones within the diaper. One such example may include thus use of said novel laminate in the construction of a waist region wherein certain sections of the waist may provide a tighter fit than in other sections. Other practical product applications of said novel laminate may be found in the following co-pending, commonly-owned patent application: U.S. Ser. No. 60/557,225, entitled “DISPOSABLE ABSORBENT ARTICLES WITH COMPONENTS HAVING BOTH PLASTIC AND ELASTIC PROPERTIES”, to Autran et al, filed on Mar. 29, 2004.

All documents cited are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An extensible laminate comprising:
a first web material;
a second web material;
a first elastic and a second elastic having different stretch properties, said elastics being laminated between said first and second materials, said elastics having substantially the same equilibrium points within the laminate.

2. The extensible laminate of claim 1 wherein said elastics are pre-strained at different strain rates.

3. The extensible laminate of claim 1 wherein said elastics have different basis weight.

4. The extensible laminate of claim 1 wherein said elastics have different diameters.

5. The extensible laminate of claim 1 further comprising a first stretch region containing multiple elastics and a second stretch region also containing multiple elastics, wherein the spacing between elastics in said first region is different than the spacing in said second region.

6. The extensible laminate of claim 1 wherein said elastics are constructed of different materials.

7. The extensible laminate of claim 1 wherein said elastics are extruded in situ.

8. The extensible laminate of claim 1 used within the construction of an absorbent article to provide at least two distinct stretch zones.

9. The extensible laminate of claim 1 used within the construction of a disposable diaper to provide at least two distinct stretch zones.
